(19) United States
(12) Patent Application Publication
(10) Pub. No.: US 2019/0244160 A1
(43) Pub. Date: Aug. 8, 2019

(54) ORDER PROCESSING METHOD AND APPARATUS

(71) Applicant: Beijing Xiaodu Information Technology Co., Ltd., Beijing (CN)

(72) Inventors: Li Ze, Beijing (CN); CHEN Yayun, Beijing (CN); DOU Yanbin, Beijing (CN)

(21) Appl. No.: 16/389,815

(22) Filed: Apr. 19, 2019

Related U.S. Application Data
(63) Continuation of application No. PCT/CN2017/118781, filed on Dec. 26, 2017.

(30) Foreign Application Priority Data
Jun. 1, 2017 (CN) 201710404971.6

(51) Int. Cl. G06Q 10/08; G06Q 30/06; G06Q 10/06; G06Q 10/10; G06N 7/00

(52) U.S. Cl. CPC G06Q 10/083; G06Q 30/0611; G06N 7/005; G06Q 10/067; G06Q 10/1097; G06Q 30/0635

(57) ABSTRACT

Embodiments of this disclosure provide an order processing method and apparatus, and a server. The method includes: determining a first order taking model obtained by training historical allocation orders; calculating, based on an order subjective attribute that affects a probability of taking an order, an order taking willingness of a to-be-allocated order by using the first order taking model; and allocating the to-be-allocated order to a delivery person that matches the order taking willingness. According to technical solutions provided in the embodiments of this disclosure, order taking rate is improved, and delivery quality is improved.

### CROSS REFERENCE

This application is a continuation of International Patent Application No. PCT/CN2017/118781, filed on Dec. 26, 2017 and entitled “ORDER PROCESSING METHOD AND DEVICE”, which claims priority to Chinese Patent Application No. 201710404971.6, filed Jun. 1, 2017 and entitled “ORDER PROCESS METHOD AND DEVICE”, all of which are incorporated herein by reference in their entirety.

### TECHNICAL FIELD

Embodiments of this disclosure relate to the field of computer application technologies, and in particular, to an order processing method and apparatus.

### BACKGROUND

In this e-commerce era, logistics services have been developing rapidly, and the number of delivery orders continuously increases. Therefore, delivery scheduling is becoming increasingly important.

Delivery scheduling means allocating delivery orders to delivery persons, who would them implement delivery operations such as pickup or delivery based on the delivery order.

In the prior art, order allocation is usually implemented through real-time bidding, wherein a server pushes a delivery order to clients corresponding to nearby delivery persons, and the clients would submit order bidding requests to take the delivery order for the delivery persons. The server allocates, based on the order bidding time, the delivery order to a delivery person who bids the order first. However, in this method, some delivery orders are not taken by any person, and consequently the delivery quality is affected.

### SUMMARY

Embodiments of this disclosure provide an order processing method and apparatus, so as to resolve the problem of relatively low delivery quality in the prior art.

According to a first aspect of an embodiment of this disclosure, an order processing method is provided, including:

determining a first order taking model obtained by training historical allocation orders;

calculating, based on an order subjective attribute that affects a probability of taking an order, an order taking willingness of a to-be-allocated order by using the first order taking model; and

allocating the to-be-allocated order to a delivery person that matches the order taking willingness.

Optionally, the first order taking model is obtained through training in advance in the following manner:

determining the order subjective attribute and an order objective attribute that affect a probability of taking an order;

constructing the first order taking model by using the order subjective attribute;

constructing a second order taking model by using the order objective attribute; and

based on order subjective attributes and order objective attributes of historical allocation orders, associatively training the first order taking model and the second order taking model, to separately obtain model parameters of the first order taking model and the second order taking model.

Optionally, a step of constructing the first order taking model includes:

using a weighted summation formula of the order subjective attribute as the first order taking model; and

a step of constructing the second order taking model includes:

using a weighted summation formula of the order objective attribute as the second order taking model.

Optionally, a step of associatively training the first order taking model and the second order taking model includes:

based on an association that a calculation result of the first order taking model is the same as a calculation result of the second order taking model, using the order subjective attributes and the order objective attributes that correspond to the historical allocation orders as training samples, and associatively training the first order taking model and the second order taking model, to separately obtain the model parameters of the first order taking model and the second order taking model.

Optionally, the step of allocating includes:

determining a scheduling type that matches the order taking willingness; and

allocating the to-be-allocated order to a delivery person corresponding to the scheduling type.

According to a second aspect, an order processing apparatus is provided, including:

a determining module, configured to determine a first order taking model obtained by training historical allocation orders;

a calculation module, configured to calculate, based on an order subjective attribute that affects a probability of taking an order, an order taking willingness of a to-be-allocated order by using the first order taking model; and

an allocation module, configured to allocate the to-be-allocated order to a delivery person that matches the order taking willingness.

Optionally, the apparatus further includes:

an attribute determining module, configured to determine the order subjective attribute and an order objective attribute that affect a probability of taking an order;

a first construction module, configured to construct the first order taking model by using the order subjective attribute;

a second construction module, configured to construct the second order taking model by using the order objective attribute; and

a first model training module, configured to: based on order subjective attributes and order objective attributes of historical allocation orders, associatively train the first order taking model and the second order taking model, to separately obtain model parameters of the first order taking model and the second order taking model.

Optionally, the first construction module is specifically configured to: use a weighted summation formula of the order subjective attribute as the first order taking model; and

the second construction module is specifically configured to: use a weighted summation formula of the order objective attribute as the second order taking model.

Optionally, the first model training module is specifically configured to: based on an association that a calculation result of the first order taking model is the same as a calculation result of the second order taking model, use the order subjective attributes and the order objective attributes that correspond to the historical allocation orders as training samples, and associatively train the first order taking model and the second order taking model, to separately obtain the model parameters of the first order taking model and the second order taking model.

Optionally, the allocation module includes:

a determining unit, configured to determine a scheduling type that matches the order taking willingness; and

an allocation unit, configured to allocate the to-be-allocated order to a delivery person corresponding to the scheduling type.

In the embodiments of this disclosure, a first order taking model is obtained by training historical allocation orders; based on an order subjective attribute that affects a probability of taking an order, an order taking willingness of a to-be-allocated order is calculated by using the first order taking model, so that the to-be-allocated order may be allocated to a delivery person that matches the order taking willingness. The delivery person that matches the order taking willingness has a higher probability of taking the to-be-allocated order. Therefore, the chance that an order is not taken by any person is reduced, an order taking rate of an order is improved, and delivery quality is improved.

These aspects or other aspects of this disclosure are more concise and understandable in the description of the following embodiments.

### BRIEF DESCRIPTION OF DRAWINGS

To discuss the technical solutions in the embodiments of this disclosure or in the prior art more clearly, the following describes the embodiments or the prior art in connection with the accompanying drawings. Apparently, the accompanying drawings show only some embodiments of this disclosure, and persons of ordinary skill in the art may still derive other drawings from these accompanying drawings without inventive efforts.

FIG. 1 is a flowchart of an embodiment of an order processing method according to an embodiment of this disclosure;

FIG. 2 is a flowchart of another embodiment of an order processing method according to an embodiment of this disclosure;

FIG. 3A and FIG. 3B are a flowchart of another embodiment of an order processing method according to an embodiment of this disclosure;

FIG. 4 is a schematic structural diagram of an embodiment of an order processing apparatus according to an embodiment of this disclosure;

FIG. 5 is a schematic structural diagram of another embodiment of an order processing apparatus according to an embodiment of this disclosure;

FIG. 6 is a schematic structural diagram of another embodiment of an order processing apparatus according to an embodiment of this disclosure; and

FIG. 7 is a schematic structural diagram of an embodiment of a server according to an embodiment of this disclosure.

### DESCRIPTION OF EMBODIMENTS

To make persons skilled in the art understand the technical solutions in this disclosure better, the following describes the technical solutions in the embodiments of this disclosure with reference to the accompanying drawings in the embodiments of this disclosure.

Some procedures described in the specification, claims, and accompanying drawings of this disclosure include a plurality of operations that occur in a specific order. However, it should be understood that these operations may not be performed in the order of the operations provided in this specification or may be performed concurrently. Operation sequence numbers such as 101 and 102 are only intended to distinguish between different operations, and the sequence numbers do not represent any order of operation. In addition, these procedures may include more or fewer operations, and these operations may be performed in order or performed concurrently. It should be noted that “first”, “second”, and the like described in this specification are intended to distinguish between different messages, devices, modules, and the like, do not represent an order, and do not necessarily indicate different types.

The technical solutions in the embodiments of this disclosure are mainly applied to a service scenario involving logistics delivery, and in particular, to an e-commerce scenario that is implemented based on O2O (Online To Offline, Online To Offline). For example, in a takeout delivery scenario, a delivery order is usually generated based on an online transaction order, and is used to instruct a delivery person to implement a delivery operation such as pickup and/or delivery. Therefore, delivery scheduling is required to allocate the delivery order to the delivery person.

In the prior art, order allocation is implemented in an order bidding mode. Delivery orders have different delivery incomes and different delivery distances, and the delivery person will determine whether to bid an order based on his individual requirement or preference. However, the server directly pushes the orders without taking the delivery person into consideration, and some delivery orders are not taken by any person. Consequently, the delivery order may have to be canceled.

To improve delivery quality, the inventors find, through research, that if it can be predetermined whether a to-be-allocated order may be taken by a delivery person, and the to-be-allocated order is allocated to a delivery person with a high probability of taking the order, the order taking rate of the to-be-allocated order is greatly improved, and the delivery quality is improved. Therefore, the inventors propose the technical solutions in the embodiments of this disclosure. In the embodiments of this disclosure, based on an order subjective attribute that affects a probability of taking an order, an order taking willingness of a to-be-allocated order is first calculated by using a first order taking model, where the first order taking model is obtained by training historical allocation orders, and the order taking willingness may represent a probability of taking the to-be-allocated order. In this case, the to-be-allocated order may be allocated to a delivery person that matches the order taking willingness. Different delivery persons may correspond to different order taking willingness, and the delivery person that matches the order taking willingness has a high probability of taking the to-be-allocated order. According to the embodiments of this disclosure, the order taking willingness is calculated by using the first order taking model, allocation of the to-be-allocated order may be instructed based on taking statuses of historical allocation orders, and the to-be-allocated order is allocated based on the delivery person that matches the order taking willingness instead of any delivery person. Therefore, the chance that the to-be-allocated order is not taken by any person is reduced, and delivery quality of each delivery order is ensured.

The following describes the technical solutions in the embodiments of this disclosure with reference to the accompanying drawings in the embodiments of this disclosure. Apparently, the described embodiments are merely some but not all of the embodiments of this disclosure. All other embodiments obtained by persons skilled in the art based on the embodiments of this disclosure without inventive efforts shall fall within the protection scope of this disclosure.

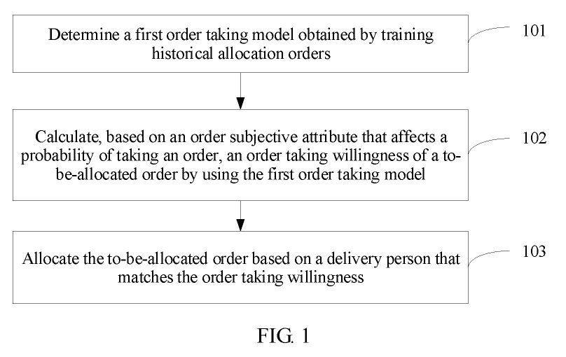

FIG. 1 is a flowchart of an embodiment of an order processing method according to an embodiment of this disclosure. The method may include the following steps.

101. Determine a first order taking model obtained by training historical allocation orders.

The first order taking model is obtained by training the historical allocation orders, so that allocation of a to-be-allocated order may be instructed based on taking statuses of the historical allocation orders, thereby improving an order taking rate of the to-be-allocated order, and ensuring delivery quality. The historical allocation order is a delivery order that is historically allocated to a delivery person.

102. Calculate, based on an order subjective attribute that affects a probability of taking an order, an order taking willingness of a to-be-allocated order by using the first order taking model.

The to-be-allocated order is a delivery order that is to be allocated.

It should be noted that, if the to-be-allocated order is successfully allocated to any delivery person, and the any delivery person implements a delivery operation of the to-be-allocated order, it indicates that the to-be-allocated order is successfully taken. For example, in an order bidding mode, the any delivery person may send an order bidding request by using a client, to request to take the to-be-allocated order. The to-be-allocated order is allocated to a delivery person that successfully bids an order, and the delivery person that successfully bids an order implements the delivery operation of the to-be-allocated order. It indicates that the to-be-allocated order is successfully taken.

Optionally, the order subjective attribute may include at least a delivery income, a delivery distance, and the like, and may further include a delivery person level and the like.

The delivery income is an income that is obtained after the delivery person implements order delivery. Different delivery orders correspond to different delivery incomes. It may be understood that a higher delivery income indicates a higher probability of taking the delivery order.

The delivery distance may be a distance between a start address and a destination address of the delivery order. It may be understood that a shorter delivery distance indicates a higher probability of taking the delivery order.

Delivery persons of different delivery person levels obtain different delivery rewards from each delivery order, and therefore a delivery person with a higher delivery person level indicates a higher probability of taking the delivery order.

It can be learned from the foregoing description that the order taking willingness of the to-be-allocated order that is obtained through calculation may represent a probability of taking the to-be-allocated order. A larger order taking willingness may indicate a higher taking probability, and a smaller order taking willingness may indicate a lower taking probability.

Optionally, based on the order subjective attribute that affects the probability of taking an order, an order subjective attribute of the to-be-allocated order may be first determined, so that the order taking willingness of the to-be-allocated order is obtained through calculation based on the order subjective attribute of the to-be-allocated order.

The delivery order includes the start address and the destination address. The delivery operation of the delivery order includes: The delivery person obtains a delivery object from the start address, and then sends the delivery object to the destination address. For example, in a takeout scenario, the start address may be a merchant address, and the destination address may be a customer address. In a cash on delivery service scenario, the start address may be a distribution point address, and the destination address is a receiver address; or the start address is a sender address, and the destination address is a distribution point address, and the like.

A delivery distance of the to-be-allocated order may be obtained through calculation based on the start address and the destination address of the delivery order.

A delivery income of the to-be-allocated order is set by a system when the allocation order is generated.

A delivery person level of the to-be-allocated order may be determined in the following manner:

determining, based on a start address of the to-be-allocated order, delivery persons that are located in an area range corresponding to the start address; and

using an average delivery person level of the delivery persons within the area range as the delivery person level of the to-be-allocated order.

103. Allocate the to-be-allocated order to a delivery person that matches the order taking willingness.

Different delivery persons have different subjective order taking willingness. To be specific, for any delivery order, some delivery persons have relatively strong subjective order taking willingness, but some delivery persons have relatively low subjective order taking willingness. Therefore, correspondences between different delivery persons and different order taking willingness may be set. A delivery person with a relative strong subjective order taking willingness may correspond to a relatively small order taking willingness. This may ensure that a to-be-allocated order with a lower taking probability is allocated to a delivery person with a strong subjective order taking willingness, thereby improving an order taking rate of the to-be-allocated order, and ensuring delivery quality.

Optionally, the to-be-allocated order may be allocated to a delivery person that matches the order taking willingness and whose current delivery location matches the start address of the to-be-allocated order.

The current delivery location may be a current location of the delivery person or a location of the delivery person when the allocated order is delivered. The location of the delivery person when the allocated order is delivered may be the destination address of the allocated order. The allocated order is a delivery order that is allocated to the delivery person.

Optionally, there may be a plurality of delivery persons that match the order taking willingness. Based on the delivery person that matches the order taking willingness, the allocation order may be allocated in the order bidding mode. Certainly, the allocation order may alternatively be allocated in another allocation mode, for example, directly allocated to any one of the delivery persons. Details are described in the following embodiment.

Subjective order taking willingness of different delivery persons may be preset. Certainly, because many delivery persons participate in order delivery, to reduce algorithm complexity, optionally, in the embodiment of this disclosure, a plurality of scheduling types may be set, and at least one delivery person may be correspondingly configured for each scheduling type. Optionally, a delivery person may belong to one or more scheduling types.

The delivery persons of the same scheduling type have the same subjective order taking willingness. Each scheduling type may correspond to one subjective order taking willingness. Therefore, correspondences between different scheduling types and different order taking willingness may be specifically set. A delivery person of a scheduling type with a relatively strong subjective order taking willingness corresponds to a relatively small order taking willingness, thereby ensuring that a to-be-allocated order with a lower taking probability is allocated to the delivery person of the scheduling type with the relatively strong subjective order taking willingness.

Therefore, in some embodiments, the allocating the to-be-allocated order to a delivery person that matches the order taking willingness may include:

determining a scheduling type that matches the order taking willingness; and

allocating the to-be-allocated order to a delivery person corresponding to the scheduling type.

Optionally, the to-be-allocated order may be allocated to a delivery person that corresponds to the scheduling type and whose current delivery location matches the start address of the to-be-allocated order.

In addition, a delivery person in the prior art may only participate in order allocation in the order bidding mode, and it is possible that an order is still not taken by any person in the order bidding mode. Therefore, to further ensure delivery quality, in the embodiments of this disclosure, different scheduling types may correspond to a plurality of allocation modes, for example, the plurality of allocation modes may include at least the order bidding mode. Same as the prior art, the plurality of allocation modes may further include an assignment mode. To be specific, the to-be-allocated order is directly allocated to any delivery person, and the delivery person implements a delivery operation, so as to avoid the situation where a to-be-allocated order with a small order taking willingness may fail to be taken even if the to-be-allocated order is allocated to a delivery person with a strong subjective order taking willingness.

Therefore, optionally, in some embodiments, if the scheduling type corresponds to the assignment mode, the allocating the to-be-allocated order to a delivery person corresponding to the scheduling type may include:

determining any delivery person corresponding to the scheduling type; and

allocating the to-be-allocated order to the any delivery person.

The to-be-allocated order is allocated to the any delivery person, to be specific, the delivery person implements a delivery operation, to take the to-be-allocated order.

Specifically, any delivery person that corresponds to the scheduling type and whose current delivery location matches the start address of the to-be-allocated order may be determined.

If the scheduling type corresponds to the order bidding mode, the allocating the to-be-allocated order to a delivery person corresponding to the scheduling type includes:

determining at least one delivery person corresponding to the scheduling type;

pushing order bidding information of the to-be-allocated order to a client corresponding to the at least one delivery person;

determining, based on an order bidding request sent by the client corresponding to the at least one delivery person, a delivery person that successfully bids an order; and

allocating the to-be-allocated order to the delivery person that successfully bids an order, to be specific, implementing, by the delivery person that successfully bids an order, a delivery operation, to take the to-be-allocated order.

Specifically, at least one delivery person that corresponds to the scheduling type and whose current delivery location matches the start address of the to-be-allocated order may be determined.

In some embodiments, a scheduling type that matches the order taking willingness may be determined based on determining threshold ranges corresponding to different scheduling types.

To be specific, a scheduling type corresponding to a determining threshold range in which the order taking willingness is located is a scheduling type that matches the order taking willingness.

An example in which the plurality of scheduling types include at least a first type, a second type, and a third type is used for description below. A subjective order taking willingness of the first type is weaker than a subjective order taking willingness of the second type, and the subjective order taking willingness of the second type is weaker than a subjective order taking willingness of the third type.

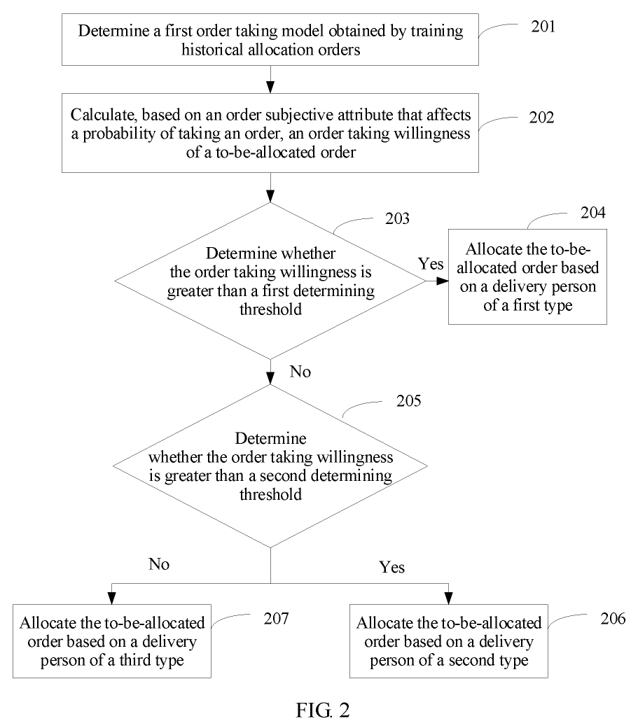

FIG. 2 is a flowchart of another embodiment of an order processing method according to an embodiment of this disclosure. The method may include the following steps.

201. Determine a first order taking model obtained by training historical allocation orders.

202. Calculate, based on an order subjective attribute that affects a probability of taking an order, an order taking willingness of a to-be-allocated order.

203. Determine whether the order taking willingness is greater than a first determining threshold; and if the order taking willingness is greater than the first determining threshold, perform step 204, or if the order taking willingness is not greater than the first determining threshold, perform step 205.

204. Allocate the to-be-allocated order to a delivery person of a first type.

If the order taking willingness is greater than the first determining threshold, a scheduling type matching the order taking willingness is the first type.

205. Determine whether the order taking willingness is greater than a second determining threshold; and if the order taking willingness is greater than the second determining threshold, perform step 206, or if the order taking willingness is not greater than the second determining threshold, perform step 207.

206. Allocate the to-be-allocated order to a delivery person of a second type.

To be specific, if the order taking willingness is less than the first determining threshold and greater than the second determining threshold, it can be determined that a scheduling type matching the order taking willingness is the second type.

Optionally, if the order taking willingness is equal to the first determining threshold, it can be determined that the order taking willingness matches the first type or the second type.

207. Allocate the to-be-allocated order to a delivery person of a third type.

To be specific, if the order taking willingness is less than the second determining threshold, it can be determined that a scheduling type matching the order taking willingness is the third type.

Optionally, if the order taking willingness is equal to the second determining threshold, it can be determined that the order taking willingness matches the second type or the third type.

In addition, in the embodiments of this disclosure, the first type may be a main scheduling type, and corresponds to a largest quantity of delivery persons. To further improve delivery quality, optionally:

if the order taking willingness is greater than the first determining threshold, and the order taking willingness is greater than a third determining threshold, the to-be-allocated order may be allocated to a delivery person that corresponds to the first type and whose delivery person level is higher than a preset level; or

if the order taking willingness is greater than the first determining threshold, and the order taking willingness is less than a third determining threshold, the to-be-allocated order may be allocated to a delivery person that corresponds to the first type and whose delivery person level is lower than a preset level.

Optionally, an order bidding mode is a mainstream mode of current order allocation, and costs for retaining delivery persons are not high. In practice, the first type may correspond to the order bidding mode. Therefore, a to-be-allocated order with a large order taking willingness is allocated to the delivery person of the first type, so as to ensure that the to-be-allocated order is taken.

The third type may correspond to an assignment mode, so as to ensure that a to-be-allocated order with a small order taking willingness may be taken. The delivery person of the third type cannot independently select a delivery order, and therefore costs for retaining the delivery person of the third type may be relatively high.

The second type may correspond to the order bidding mode or the assignment mode. Optionally, the second type may correspond to the order bidding mode, and a subjective order taking willingness of the second type is higher than the subjective order taking willingness of the first type, so as to ensure that an order may be taken at relatively low costs.

In practice, the delivery person of the first type may be a delivery person who performs order allocation in the order bidding mode in the prior art. Usually, orders are delivered by social idle transport capacity persons, and especially, in a takeout scenario, these transport capacity persons are also referred to as crowd-sourcing persons.

To avoid the chance that an order is not taken by any crowd-sourcing person, the delivery person of the second type may be configured. The second type is instructive in practice. The second type may be a self-built special delivery type, to be specific, an order is delivered by a self-built transport capacity person. Compared with a crowd-sourcing person, the delivery person of a special delivery type has a stronger subjective order taking willingness.

The third type is instructive in practice. The third type may be a self-built assignment type, and an order is allocated in only the assignment mode according to the third type. To be specific, a delivery person belonging to the assignment type can receive only an order allocated by a system, and cannot independently select a delivery order.

Therefore, based on the delivery person of the first type, the to-be-allocated order is allocated in the order bidding mode; based on the delivery person of the second type, the to-be-allocated order is allocated in the order bidding mode; based on the delivery person of the third type, the to-be-allocated order is allocated in the assignment mode. For a specific process of allocating the to-be-allocated order in the order bidding mode and a specific process of allocating the to-be-allocated order in the assignment mode, refer to the foregoing descriptions, and details are not described herein again.

A subjective order taking willingness of the delivery person of the third type is greater than that of the delivery person of the second type, and the subjective order taking willingness of the delivery person of the second type is greater than that of the delivery person of the first type. Correspondingly, costs for retaining the delivery person of the third type are higher than costs for retaining the delivery person of the second type, and the costs for retaining the delivery person of the second type are higher than costs for retaining the delivery person of the first type. Therefore, according to the embodiment of this disclosure, based on an order taking willingness of a to-be-allocated order, the to-be-allocated order may be determined to be allocated to a delivery person of a scheduling type, so that delivery quality may be improved while costs are reduced.

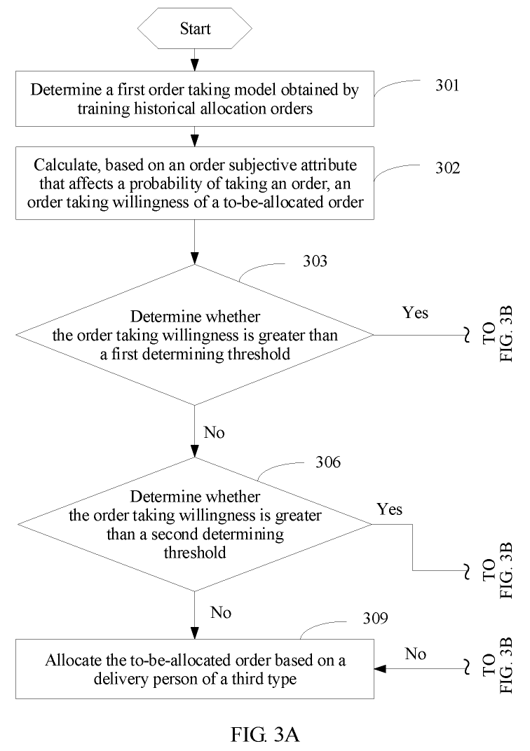

If the to-be-allocated order is allocated in the order bidding mode based on the delivery person of the first type, it is still possible that an order is not taken by any person. To further improve delivery quality, an embodiment of this disclosure provides another order processing method, and a flowchart of the method is shown in FIG. 3A and FIG. 3B. The method may include the following steps.

301. Determine a first order taking model obtained by training historical allocation orders.

302. Calculate, based on an order subjective attribute that affects a probability of taking an order, an order taking willingness of a to-be-allocated order.

303. Determine whether the order taking willingness is greater than a first determining threshold; and if the order taking willingness is greater than the first determining threshold, perform step 304, or if the order taking willingness is not greater than the first determining threshold, perform step 306.

304. Allocate the to-be-allocated order to a delivery person of a first type.

305. Determine whether the to-be-allocated order is taken after first preset duration; and if the to-be-allocated order is not taken after the first preset duration, perform step 307, or if the to-be-allocated order is taken after the first preset duration, end the procedure.

306. Determine whether the order taking willingness is greater than a second determining threshold; and if the order taking willingness is greater than the second determining threshold, perform step 307, or if the order taking willingness is not greater than the second determining threshold, perform step 309.

307. Allocate the to-be-allocated order to a delivery person of a second type.

If the to-be-allocated order is allocated in an order bidding mode based on the delivery person of the second type, it is still possible that an order is not taken by any person. Therefore, the method may further include the following steps:

308. Determine whether the to-be-allocated order is taken after second preset duration; and if the to-be-allocated order is not taken after the second preset duration, perform step 309, or if the to-be-allocated order is taken after the second preset duration, end the procedure.

309. Allocate the to-be-allocated order to a delivery person of a third type.

Specifically, the to-be-allocated order is allocated in an assignment mode based on the delivery person of the third type. Therefore, it can be ensured that the to-be-allocated order is taken, so as to ensure an order taking rate of the to-be-allocated order, and improve delivery quality.

In the foregoing examples, the first order taking model is obtained by training the historical allocation orders. When a plurality of scheduling types are included, the historical allocation order may be specifically a delivery order that is allocated in the order bidding mode.

The first order taking model may be obtained by training the historical allocation orders. Therefore, optionally, in some embodiments, the first order taking model may be obtained through training in advance in the following manner:

determining the order subjective attribute and an order objective attribute that affect a probability of taking an order;

constructing the first order taking model by using the order subjective attribute;

constructing a second order taking model by using the order objective attribute; and

based on order subjective attributes and order objective attributes that correspond to the historical allocation orders, associatively training the first order taking model and the second order taking model, to separately obtain model parameters of the first order taking model and the second order taking model.

The order subjective attribute may include a delivery income, a delivery distance, a delivery person level, and the like. The order objective attribute may include an order read rate, an order waiting time, and the like.

The order read rate may be determined in the following manner:

When an order is allocated, a server first pushes order information of a delivery order to a client, and then the client outputs the order information, where the order information may include, for example, a delivery income and/or a delivery distance of the delivery order. When detecting a triggering request of a delivery person for the order information, the client sends an order information obtaining request to the server end to request to obtain detailed information about the delivery order, and then outputs the detailed information, and the like. A quantity of order information obtaining requests that are received by the server for the delivery orders may be used as an order read quantity, and a ratio of the order read quantity to an order pushing quantity is the order read rate.

The order waiting time may be waiting duration of each delivery order from a time at which the delivery order is allocated to any delivery person to a time at which the delivery order is taken. If the delivery order is not taken by any person and is canceled, the order waiting time may be waiting duration from a time at which the delivery order is allocated to any delivery person to a time at which the delivery order is canceled.

If the order read rate is higher, it indicates that an order taking willingness of the delivery person for the delivery order is lower; and if the order waiting time is longer, it indicates that an order taking willingness of the delivery person for the delivery order is lower.

Optionally, a step of constructing the first order taking model may include:

using a weighted summation formula of the order subjective attribute as the first order taking model; and

a step of constructing the second order taking model may include:

using a weighted summation formula of the order objective attribute as the second order taking model.

For example, it is assumed that the order subjective attribute includes an order income I, a delivery distance M, and a delivery person level S, the first order taking model may be:

a*I+b*M+c*S, where

a, b, and c are weight parameters, namely, model parameters of the first order taking model; and a process of training the first order taking model is a process of calculating the model parameter.

It is assumed that the order objective attribute includes an order read rate R and an order waiting duration T, and the second order taking model may be:

d*R+e*T, where

d and e are weight parameters, namely, model parameters of the second order taking model.

Because both the order subjective attribute and the order objective attribute are factors that affect the probability of taking an order, the first order taking model may be equal to the second order taking model, so as to obtain a linear equation in twovariables: a*I+b*M+c*S=d*R+e*T.

The historical allocation orders are used as training samples, and then the model parameters of the first order taking model and the second order taking model may be obtained by solving the equation.

Therefore, in some embodiments, a step of associatively training the first order taking model and the second order taking model may include:

based on an association that a calculation result of the first order taking model is the same as a calculation result of the second order taking model, using the order subjective attributes and the order objective attributes that correspond to the historical allocation orders as training samples, and associatively training the first order taking model and the second order taking model, to separately obtain the model parameters of the first order taking model and the second order taking model.

After the first order taking model is obtained through training, the order taking willingness of the to-be-allocated order may be calculated by using the first order taking model. Therefore, steps of calculating the order taking willingness may include:

determining an order subjective attribute corresponding to the to-be-allocated order; and

calculating, based on the order subjective attribute corresponding to the to-be-allocated order, the order taking willingness by using the first order taking model.

When the plurality of scheduling types include the first type, the second type, and the third type, a scheduling type that matches the order taking willingness may be determined by using a determining threshold range.

The historical allocation order that is used to train the first order taking model and the second order taking model may be specifically an taken order that is historically recorded. The taken order is a delivery order that is successfully taken by the delivery person.

The first determining threshold and the second determining threshold in the determining threshold range may be predetermined in the following manner:

constructing a first non-order taking model by using the order subjective attribute;

constructing a second non-order taking model by using the order objective attribute;

based on order subjective attributes and order objective attributes of non-taken orders that are historically recorded, associatively training the first non-order taking model and the second non-order taking model, to separately obtain model parameters of the first non-order taking model and the second non-order taking model;

calculating reference willingness of the taken orders based on the first order taking model or the second order taking model;

calculating an average value of the reference willingness of the taken orders, to obtain a first reference value;

calculating reference willingness of the non-taken orders based on the first non-order taking model or the second non-order taking model;

calculating an average value of the reference willingness of the non-taken orders, to obtain a second reference value; and

determining the first determining threshold and the second determining threshold based on the first reference value and/or the second reference value.

Optionally, the weighted summation formula of the order subjective attribute may be used as the first non-order taking model; and the weighted summation formula of the order objective attribute may be used as the second non-order taking model.

Based on an association that a calculation result of the first non-order taking model is the same as a calculation result of the second non-order taking model, order subjective attributes and order objective attributes of non-taken orders that are historically recorded are used as training samples, and the first non-order taking model and the second non-order taking model are associatively trained, to separately obtain model parameters of the first non-order taking model and the second non-order taking model.

Further, a model formula of the first order taking model is the same as that of the first non-order taking model, but model parameters obtained through training are different. A model formula of the second order taking model is the same as that of the second non-order taking model, but model parameters obtained through training are different.

In a possible implementation, it is assumed that a first reference value is represented by G1, and a second reference value is represented by G2.

The first determining threshold may be 0.8*G2; and the second determining threshold may be 0.5*G2.

Delivery persons of the first type may be divided based on the delivery person level. Therefore, based on a comparison between the order taking willingness and a third determining threshold, a delivery person corresponding to the delivery person level may be selected for allocation of the to-be-allocated order.

Optionally, the third determining threshold may be determined based on the first reference value and/or the second reference value.

In a possible implementation, the third determining threshold may be (G1+G2)*0.5.

It can be learned from the foregoing description that the first type is a main scheduling type and corresponds to the order bidding mode, and a largest quantity of delivery persons may be configured for the first type. The delivery person of the first type may be a delivery person who performs order allocation in the order bidding mode in the prior art. Model training may be performed based on only a historical allocation order allocated to the delivery person of the first type.

Therefore, the taken order that is historically recorded and that is used to train the first order taking model and the second order taking model may be an taken order that is historically allocated to the delivery person of the first type.

The non-taken order that is historically recorded and that is used to train the first non-order taking model and the second non-order taking model may be a non-taken order that is historically allocated to the delivery person of the first type. When the non-taken order is allocated to the delivery person of the first type, no delivery person participates in order bidding. In this case, a delivery person level of the non-taken order may be an average delivery person level of delivery persons that receive order bidding information.

According to the foregoing described logical process, a non-taken order of a delivery person of the first type may be taken by a delivery person of the second type or a delivery person of the third type. Therefore, order waiting duration of the non-taken order may be waiting duration from a time at which the non-taken order starts to be allocated to a time at which the non-taken order is finally taken. Certainly, the order waiting duration may be waiting duration from a time at which the non-taken order starts to be allocated to a time at which allocation of the non-taken order to the delivery person of the first type is canceled, namely, the foregoing first preset duration.

In addition, the taken order that is used to train the first order taking model and the second order taking model may be an taken order that is historically allocated to the delivery person of the first type. The non-taken order that is used to train the first non-order taking model and the second non-order taking model may be a non-taken order that is historically allocated to the delivery person of the first type.

Therefore, optionally, in some embodiments, when the order taking willingness of the to-be-allocated order is calculated by using the first order taking model, the delivery person level of the order subjective attribute of the to-be-allocated order may be specifically determined in the following manner:

determining, based on a start address of the to-be-allocated order, delivery persons that are located in an area range corresponding to the start address and that belong to the first type or delivery persons corresponding to the order bidding mode.

Then, an average delivery person level of the delivery persons within the area range is used as the delivery person level corresponding to the to-be-allocated order.

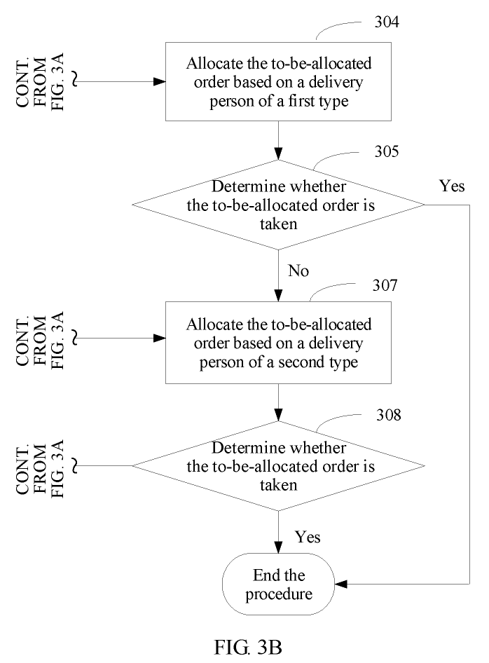

FIG. 4 is a schematic structural diagram of an embodiment of an order processing apparatus according to an embodiment of this disclosure. The apparatus may include:

a determining module 401, configured to determine a first order taking model obtained by training historical allocation orders; and

a calculation module 402, configured to calculate, based on an order subjective attribute that affects a probability of taking an order, an order taking willingness of a to-be-allocated order by using the first order taking model.

The order subjective attribute may include a delivery income, a delivery distance, and the like, and may further include a delivery person level and the like.

Optionally, the calculation module may determine, based on the order subjective attribute that affects the probability of taking an order, an order subjective attribute of the to-be-allocated order, and obtain the order taking willingness of the to-be-allocated order through calculation based on the order subjective attribute of the to-be-allocated order.

When the order subjective attribute includes the delivery person level, the apparatus may further include:

a level determining module, configured to: determine, based on a start address of the to-be-allocated order, delivery persons that are located in an area range corresponding to the start address; and use an average delivery person level of the delivery persons within the area range as the delivery person level of the to-be-allocated order.

An allocation module 403 is configured to allocate the to-be-allocated order to a delivery person that matches the order taking willingness.

Optionally, the allocation module may allocate the to-be-allocated order to a delivery person that matches the order taking willingness and whose current delivery location matches the start address of the to-be-allocated order.

To reduce algorithm complexity, optionally, in this embodiment of this disclosure, a plurality of scheduling types may be set, and at least one delivery person may be correspondingly configured for each scheduling type. Optionally, a delivery person may belong to one or more scheduling types.

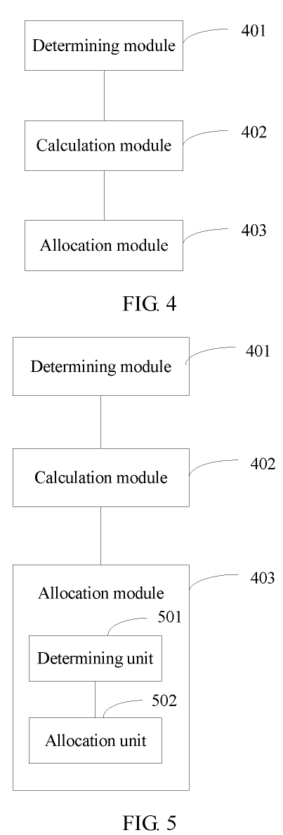

Therefore, in another embodiment, as shown in FIG. 5, a difference between the embodiment shown in FIG. 5 and the embodiment shown in FIG. 4 lies in that the allocation module 403 may include:

a determining unit 501, configured to determine a scheduling type that matches the order taking willingness; and

an allocation unit 502, configured to allocate the to-be-allocated order to a delivery person corresponding to the scheduling type.

Optionally, the determining unit may allocate the to-be-allocated order to a delivery person that corresponds to the scheduling type and whose current delivery location matches the start address of the to-be-allocated order.

In some embodiments, the allocation unit may be specifically configured to:

if the scheduling type corresponds to an assignment mode, determine any delivery person corresponding to the scheduling type; and

allocate the to-be-allocated order to the any delivery person.

The allocation unit may be specifically configured to:

if the scheduling type corresponds to an order bidding mode, determine at least one delivery person corresponding to the scheduling type;

push order bidding information of the to-be-allocated order to a client corresponding to the at least one delivery person;

determine, based on an order bidding request sent by the client corresponding to the at least one delivery person, a delivery person that successfully bids an order; and

allocate the to-be-allocated order to the delivery person that successfully bids an order.

At least one delivery person that corresponds to the scheduling type and whose current delivery location matches the start address of the to-be-allocated order may be determined.

In some embodiments, the determining unit may be specifically configured to:

determine, based on determining threshold ranges corresponding to different scheduling types, the scheduling type that matches the order taking willingness.

To be specific, a scheduling type corresponding to a determining threshold range in which the order taking willingness is located is a scheduling type that matches the order taking willingness.

In some embodiments, the plurality of scheduling types include at least a first type, a second type, and a third type. A subjective order taking willingness of the first type is weaker than a subjective order taking willingness of the second type, and the subjective order taking willingness of the second type is weaker than a subjective order taking willingness of the third type.

Therefore, the determining unit may be specifically configured to:

if the order taking willingness is greater than a first determining threshold, determine that a scheduling type matching the order taking willingness is the first type;

if the order taking willingness is less than a first determining threshold and greater than a second determining threshold, determine that a scheduling type matching the order taking willingness is the second type; or

if the order taking willingness is less than a second determining threshold, determine that a scheduling type matching the order taking willingness is the third type.

The allocation unit may be specifically configured to:

allocate the to-be-allocated order based on the delivery person of the first type if the order taking willingness is greater than the first determining threshold;

allocate the to-be-allocated order to a delivery person of the second type if the order taking willingness is less than the first determining threshold and greater than the second determining threshold; or

allocate the to-be-allocated order to a delivery person of the third type if the order taking willingness is less than the second determining threshold.

In addition, in this embodiment of this disclosure, the first type may be a main scheduling type, and corresponds to a largest quantity of delivery persons. To further improve delivery quality, in some embodiments, the allocation unit is specifically configured to:

if the order taking willingness is greater than the first determining threshold, and the order taking willingness is greater than a third determining threshold, allocate the to-be-allocated order to a delivery person that corresponds to the first type and whose delivery person level is higher than a preset level; or

if the order taking willingness is greater than the first determining threshold, and the order taking willingness is less than a third determining threshold, allocate the to-be-allocated order to a delivery person that corresponds to the first type and whose delivery person level is lower than a preset level.

Optionally, an order bidding mode is a mainstream mode of current order allocation, and costs for retaining delivery persons are not high. In practice, the first type and the second type may correspond to the order bidding mode, and the third type corresponds to an assignment mode.

If the to-be-allocated order is allocated in the order bidding mode, it is still possible that an order is not taken by any person. Therefore, to further ensure delivery quality, in another embodiment, as shown in FIG. 5, the apparatus further includes:

a first determining module 503, configured to: after the to-be-allocated order is allocated based on the delivery person of the first type, determine whether the to-be-allocated order is taken after first preset duration;

a first reallocation module 504, configured to: when a determining result of the first determining module is that the to-be-allocated order is taken after the first preset duration, allocate the to-be-allocated order based on the delivery person of the second type;

a second determining module 505, configured to: after the to-be-allocated order is allocated based on the delivery person of the second type, determine whether the to-be-allocated order is taken after second preset duration; and

a second reallocation module 506, configured to: when a determining result of the second determining module is that the to-be-allocated order is taken after the second preset duration, allocate the to-be-allocated order based on the delivery person of the third type.

In the foregoing embodiments, the first order taking model is obtained by training the historical allocation orders, so that allocation of a to-be-allocated order may be instructed based on taking statuses of the historical allocation orders, thereby improving an order taking rate of the to-be-allocated order, and ensuring delivery quality. The historical allocation order is a delivery order that is historically allocated to a delivery person.

When a plurality of scheduling types are included, the historical allocation order may be specifically a delivery order that is allocated in the order bidding mode.

The first order taking model may be obtained through training in advance. Therefore, the determining module is configured to determine the first order taking model that is obtained by training, in advance, a historical allocation order corresponding to the order bidding mode.

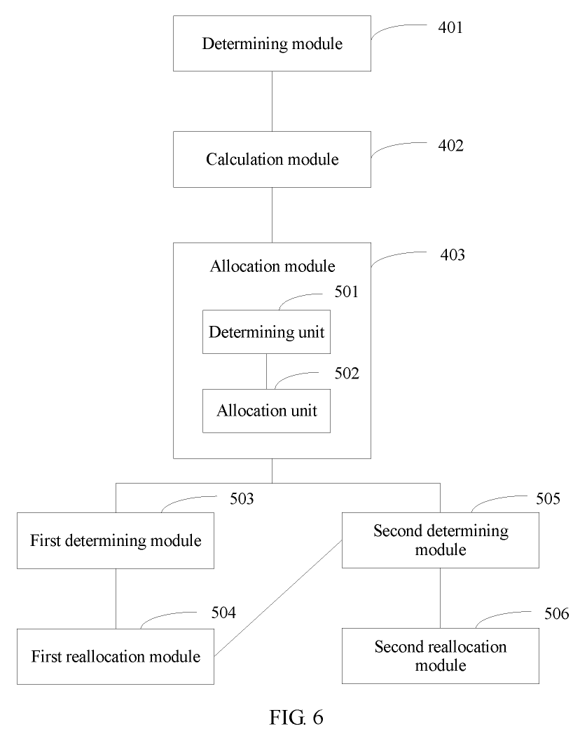

Therefore, in another embodiment, as shown in FIG. 6, a difference between the embodiment shown in FIG. 6 and the embodiment shown in FIG. 4 lies in that the apparatus further includes:

an attribute determining module 601, configured to determine the order subjective attribute and an order objective attribute that affect a probability of taking an order;

a first construction module 602, configured to construct the first order taking model by using the order subjective attribute;

a second construction module 603, configured to construct the second order taking model by using the order objective attribute; and

a first model training module 604, configured to: based on order subjective attributes and order objective attributes of historical allocation orders, associatively train the first order taking model and the second order taking model, to separately obtain model parameters of the first order taking model and the second order taking model.

Optionally, the first construction module may be specifically configured to: use a weighted summation formula of the order subjective attribute as the first order taking model.

The second construction module may be specifically configured to: use a weighted summation formula of the order objective attribute as the second order taking model.

Optionally, the first model training module may be specifically configured to: based on an association that a calculation result of the first order taking model is the same as a calculation result of the second order taking model, use the order subjective attributes and the order objective attributes that correspond to the historical allocation orders as training samples, and associatively train the first order taking model and the second order taking model, to separately obtain the model parameters of the first order taking model and the second order taking model.

After the first order taking model is obtained through training, the order taking willingness of the to-be-allocated order may be calculated by using the first order taking model. Therefore, the calculation module may be specifically configured to: determine an order subjective attribute corresponding to the to-be-allocated order;

and calculate, based on the order subjective attribute corresponding to the to-be-allocated order, the order taking willingness by using the first order taking model.

When the plurality of scheduling types include the first type, the second type, and the third type, a scheduling type that matches the order taking willingness may be determined by using a determining threshold range.

The historical allocation order that is used to train the first order taking model and the second order taking model may be specifically an taken order that is historically recorded. The taken order is a delivery order that is successfully taken by the delivery person.

In another embodiment, the apparatus may further include:

a third construction module, configured to construct a first non-order taking model by using the order subjective attribute;

a fourth construction module, configured to construct a second non-order taking model by using the order objective attribute;

a second model training module, configured to: based on order subjective attributes and order objective attributes of non-taken orders that are historically recorded, associatively train the first non-order taking model and the second non-order taking model, to separately obtain model parameters of the first non-order taking model and the second non-order taking model; and

a threshold determining module, configured to: calculate a reference willingness of the taken order based on the first order taking model or the second order taking model; calculate an average value of the reference willingness of the taken orders, to obtain a first reference value; calculate reference willingness of the non-taken orders based on the first non-order taking model or the second non-order taking model; calculate an average value of the reference willingness of the non-taken orders, to obtain a second reference value; and determine the first determining threshold and the second determining threshold based on the first reference value and/or the second reference value.

Optionally, the third construction module may use a weighted summation formula of the order subjective attribute as the first non-order taking model; and the fourth construction module may use a weighted summation formula of the order objective attribute as the second non-order taking model.

The second model training module may specifically use, based on an association that a calculation result of the first non-order taking model is the same as a calculation result of the second non-order taking model order, subjective attributes and order objective attributes of non-taken orders that are historically recorded as training samples, and associatively train the first non-order taking model and the second non-order taking model, to separately obtain model parameters of the first non-order taking model and the second non-order taking model.

It can be learned from the foregoing description that the first type is a main scheduling type and corresponds to the order bidding mode, and a largest quantity of delivery persons may be configured for the first type. The delivery person of the first type may be a delivery person who performs order allocation in the order bidding mode in the prior art. Model training may be performed based on only a historical allocation order allocated to the delivery person of the first type.

Therefore, the taken order that is historically recorded and that is used to train the first order taking model and the second order taking model may be an taken order that is historically allocated to the delivery person of the first type.

A non-taken order that is historically recorded is a non-taken order that is historically allocated to the delivery person of the first type.

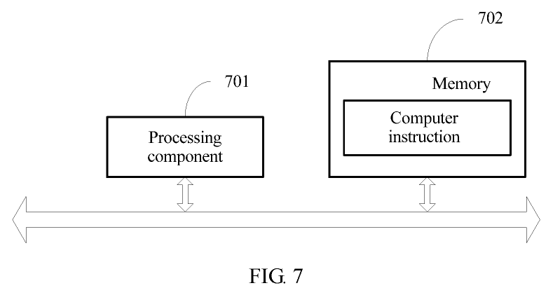

In a possible design, the order processing apparatus described in the foregoing embodiment may be configured in a server. Therefore, an embodiment of this disclosure further provides a server. As shown in FIG. 7, the server may include a processing component 701 and a memory 702.

The memory 702 is configured to store one or more computer instructions, where the one or more computer instructions are invoked and executed by the processing component 701.

The processing component 701 is configured to:

determine a first order taking model obtained by training historical allocation orders;

calculate, based on an order subjective attribute that affects a probability of taking an order, an order taking willingness of a to-be-allocated order by using the first order taking model; and

allocate the to-be-allocated order to a delivery person that matches the order taking willingness.

In addition, the processing component is further configured to perform the order processing method in any one of the foregoing embodiments.

An embodiment of this disclosure further provides a computer readable storage medium, and the computer readable storage medium stores a computer program. The computer program enables a computer to implement the order processing method in any one of the foregoing embodiments during execution.

It may be understood by persons skilled in the art that, for the purpose of convenient and brief description, for a detailed working process of the foregoing system, apparatus, and unit, reference may be made to a corresponding process in the foregoing method embodiments, and details are not described herein again.

The described apparatus embodiment is merely an example. The units described as separate parts may or may not be physically separate, and parts displayed as units may or may not be physical units, may be located in one position, or may be distributed on a plurality of network units. Some or all of the modules may be selected according to actual needs to achieve the objectives of the solutions of the embodiments. Persons of ordinary skill in the art may understand and implement the embodiments of this disclosure without creative efforts.

Based on the foregoing descriptions of the implementations, persons skilled in the art may understand that each implementation may be implemented by software in addition to a necessary general hardware platform or by hardware. Based on such an understanding, the foregoing technical solutions essentially or the part contributing to the prior art may be implemented in a form of a software product. The software product is stored in a computer-readable storage medium, such as a ROM/RAM, a magnetic disk, or an optical disc, and includes several instructions for instructing a computer device (which may be a personal computer, a server, a network device, or the like) to perform the methods described in the embodiments or some parts of the embodiments.

Finally, it should be noted that the foregoing embodiments are merely intended for describing the technical solutions of this disclosure, but not for limiting this disclosure. Although this disclosure is described in detail with reference to the foregoing embodiments, persons of ordinary skill in the art should understand that they may still make modifications to the technical solutions described in the foregoing embodiments or make equivalent replacements to some technical features thereof, without departing from the spirit and scope of the technical solutions of the embodiments of this disclosure.

1. An order processing method, comprising:
determining a first order taking model obtained by training historical allocation orders;
calculating, based on an order subjective attribute that affects a probability of taking an order, an order taking willingness of a to-be-allocated order by using the first order taking model;
determining a scheduling type that matches the order taking willingness;
if the scheduling type corresponds to an assignment mode, determining any delivery person corresponding to the scheduling type;
allocating the to-be-allocated order to the delivery person;
if the scheduling type corresponds to an order bidding mode, determining at least one delivery person corresponding to the scheduling type;
pushing order bidding information of the to-be-allocated order to a client corresponding to the at least one delivery person;
determining, based on an order bidding request sent by the client corresponding to the at least one delivery person, a delivery person that successfully bids an order; and
allocating the to-be-allocated order to the delivery person that successfully bids an order.

2. The method according to claim 1, wherein the first order taking model is obtained by training in advance in the following manner:
determining the order subjective attribute and an order objective attribute that affect a probability of taking an order;
constructing the first order taking model by using the order subjective attribute;
constructing a second order taking model by using the order objective attribute; and
based on order subjective attributes and order objective attributes of historical allocation orders, associatively training the first order taking model and the second order taking model, to separately obtain model parameters of the first order taking model and the second order taking model.

3. The method according to claim 2, wherein the step of constructing the first order taking model comprises:
using a weighted summation formula of the order subjective attribute as the first order taking model; and
the step of constructing the second order taking model comprises:
using a weighted summation formula of the order objective attribute as the second order taking model.

4. The method according to claim 2, wherein the step of associatively training the first order taking model and the second order taking model comprises:
based on an association that a calculation result of the first order taking model is the same as a calculation result of the second order taking model, using the order subjective attributes and the order objective attributes that correspond to the historical allocation orders as training samples, and associatively training the first order taking model and the second order taking model, to separately obtain the model parameters of the first order taking model and the second order taking model.

5. The method according to any one of claim 2, wherein
determining a scheduling type that matches the order taking willingness
Comprises: determining, based on threshold ranges corresponding to a different scheduling types, the scheduling type that matches the order taking willingness.

6. (canceled)

7. The method according to claim wherein
if the scheduling type corresponds to an assignment mode, determining any delivery person corresponding to the scheduling type;
allocating the to-be-allocated order to the delivery person;
if the scheduling type corresponds to an order bidding mode, determining at least one delivery person corresponding to the scheduling type;
pushing order bidding information of the to-be-allocated order to a client corresponding to the at least one delivery person;
determining, based on an order bidding request sent by the client corresponding to the at least one delivery person, a delivery person that successfully bids an order; and
allocating the to-be-allocated order to the delivery person that successfully bids an order comprises:
allocating the to-be-allocated order to a delivery person of a first type if the order taking willingness is greater than a first determining threshold;
allocating the to-be-allocated order to a delivery person of a second type if the order taking willingness is less than a first determining threshold and greater than a second determining threshold; or
allocating the to-be-allocated order to a delivery person of a third type if the order taking willingness is less than a second determining threshold;
wherein allocating the to-be-allocated order to a delivery person of a first type comprises:
if the first type corresponds to an order allocation mode, determining at least one delivery person corresponding to the first type, and allocating the to-be-allocated order to the delivery person;
if the first type corresponds to an order bidding mode, determining at least one delivery person corresponding to the first type, pushing order bidding information of the to-be-allocated order to a client corresponding to the at least one delivery person, determining, based on an order bidding request sent by the client corresponding to the at least one delivery person, a delivery person that successfully bids an order; and allocating the to-be-allocated order to the delivery person that successfully bids an order;
allocating the to-be-allocated order to a delivery person of a second type comprises:
if the second type corresponds to an order allocation mode, determining at least one delivery person corresponding to the first type, and allocating the to-be-allocated order to the delivery person;
if the second type corresponds to an order bidding mode, determining at least one delivery person corresponding to the first type, pushing order bidding information of the to-be-allocated order to a client corresponding to the at least one delivery person, determining, based on an order bidding request sent by the client corresponding to the at least one delivery person, a delivery person that successfully bids an order; and allocating the to-be-allocated order to the delivery person that successfully bids an order;
allocating the to-be-allocated order to a delivery person of a third type comprises:
if the third type corresponds to an order allocation mode, determining at least one delivery person corresponding to the first type, and allocating the to-be-allocated order to the delivery person;
if the third type corresponds to an order bidding mode, determining at least one delivery person corresponding to the first type, pushing order bidding information of the to-be-allocated order to a client corresponding to the at least one delivery person, determining, based on an order bidding request sent by the client corresponding to the at least one delivery person, a delivery person that successfully bids an order; and allocating the to-be-allocated order to the delivery person that successfully bids an order.

8. The method according to claim 7, wherein the historical allocation orders are historically recorded taken orders; and
the first determining threshold and the second determining threshold are predetermined in the following manner:
constructing a first non-order taking model by using the order subjective attribute;
constructing a second non-order taking model by using the order objective attribute;
based on order subjective attributes and order objective attributes of non-taken orders that are historically recorded, associatively training the first non-order taking model and the second non-order taking model, to separately obtain model parameters of the first non-order taking model and the second non-order taking model;
calculating a reference willingness of the taken order based on the first order taking model or the second order taking model;
calculating an average value of the reference willingness of the taken orders, to obtain a first reference value;
calculating reference willingness of the non-taken orders based on the first non-order taking model or the second non-order taking model;
calculating an average value of the reference willingness of the non-taken orders, to obtain a second reference value; and
determining the first determining threshold and the second determining threshold based on the first reference value and/or the second reference value.

9. The method according to claim 7, wherein allocating the to-be-allocated order to a delivery person of a first type if the order taking willingness is greater than a first determining threshold comprises:
if the order taking willingness is greater than the first determining threshold, and the order taking willingness is greater than a third determining threshold, allocating the to-be-allocated order to a delivery person that corresponds to the first type and whose delivery person level is higher than a preset level; or
if the order taking willingness is greater than the first determining threshold, and the order taking willingness is less than a third determining threshold, allocating the to-be-allocated order to a delivery person that corresponds to the first type and whose delivery person level is lower than a preset level.

10. The method according to claim 7, wherein the first type and the second type correspond to an order bidding mode, the third type corresponds to an assignment mode, a subjective order taking willingness of the first type is weaker than a subjective order taking willingness of the second type, and the subjective order taking willingness of the second type is weaker than a subjective order taking willingness of the third type; and
after the allocating the to-be-allocated order to a delivery person of a first type if the order taking willingness is greater than a first determining threshold, the method further comprises:
determining whether the to-be-allocated order is taken after first preset duration;
if the to-be-allocated order is not taken after the first preset duration, allocating the to-be-allocated order based on the delivery person of the second type;
determining whether the to-be-allocated order is taken after second preset duration; and
if the to-be-allocated order is not taken after the second preset duration, allocating the to-be-allocated order based on the delivery person of the third type.

11. The method according to claim 7, wherein an taken order that is historically recorded is an taken order that is historically allocated to the delivery person of the first type; and
a non-taken order that is historically recorded is a non-taken order that is historically allocated to the delivery person of the first type.

12. The method according to claim 2, wherein the order subjective attribute comprises a delivery income, a delivery distance, and a delivery person level, and the order objective attribute comprises an order read rate and an order waiting time; and
a delivery person level of the to-be-allocated order is determined in the following manner:
determining, based on a start address of the to-be-allocated order, delivery persons that are located in an area range corresponding to the start address; and
using an average delivery person level of the delivery persons within the area range as the delivery person level corresponding to the to-be-allocated order.

13. (canceled)

14. (canceled)

15. An order processing apparatus, comprising:
a determining module, configured to determine a first order taking model obtained by training historical allocation orders;
a calculation module, configured to calculate, based on an order subjective attribute that affects a probability of taking an order, an order taking willingness of a to-be-allocated order by using the first order taking model; and
an allocation module, configured to allocate the to-be-allocated order to a delivery person that matches the order taking willingness, the allocation module comprises:
a determining unit, configured to determine a scheduling type that matches the order taking willingness; and
an allocation unit, configured to:
if the scheduling type corresponds to an assignment mode, determine any delivery person corresponding to the scheduling type;
allocate the to-be-allocated order to the any delivery person; and
if the scheduling type corresponds to an order bidding mode, determine at least one delivery person corresponding to the scheduling type; push order bidding information of the to-be-allocated order to a client corresponding to the at least one delivery person; determine, based on an order bidding request sent by the client corresponding to the at least one delivery person, a delivery person that successfully bids an order; and allocate the to-be-allocated order to the delivery person that successfully bids an order.

16. The apparatus according to claim 15, further comprising:
an attribute determining module, configured to determine the order subjective attribute and an order objective attribute that affect a probability of taking an order;
a first construction module, configured to construct the first order taking model by using the order subjective attribute;
a second construction module, configured to construct the second order taking model by using the order objective attribute; and
a first model training module, configured to: based on order subjective attributes and order objective attributes of historical allocation orders, associatively train the first order taking model and the second order taking model, to separately obtain model parameters of the first order taking model and the second order taking model.

17. The apparatus according to claim 16, wherein the first construction module is specifically configured to: use a weighted summation formula of the order subjective attribute as the first order taking model; and
the second construction module is specifically configured to: use a weighted summation formula of the order objective attribute as the second order taking model.

18. The apparatus according to claim 16, wherein the first model training module is specifically configured to: based on an association that a calculation result of the first order taking model is the same as a calculation result of the second order taking model, use the order subjective attributes and the order objective attributes that correspond to the historical allocation orders as training samples, and associatively train the first order taking model and the second order taking model, to separately obtain the model parameters of the first order taking model and the second order taking model.

19. (canceled)

20. The apparatus according to claim 19, wherein the determining unit is specifically configured to: determine, based on determining threshold ranges corresponding to different scheduling types, the scheduling type that matches the order taking willingness.

21. The apparatus according to claim 20, wherein the allocation unit is specifically configured to:
allocate the to-be-allocated order to a delivery person of a first type if the order taking willingness is greater than a first determining threshold;
allocate the to-be-allocated order to a delivery person of a second type if the order taking willingness is less than a first determining threshold and greater than a second determining threshold; or
allocate the to-be-allocated order to a delivery person of a third type if the order taking willingness is less than a second determining threshold;
wherein allocating the to-be-allocated order to a delivery person of a first type comprises:
if the first type corresponds to an order allocation mode, determining at least one delivery person corresponding to the first type, and allocating the to-be-allocated order to the delivery person;
if the first type corresponds to an order bidding mode, determining at least one delivery person corresponding to the first type, pushing order bidding information of the to-be-allocated order to a client corresponding to the at least one delivery person, determining, based on an order bidding request sent by the client corresponding to the at least one delivery person, a delivery person that successfully bids an order; and allocating the to-be-allocated order to the delivery person that successfully bids an order;
allocating the to-be-allocated order to a delivery person of a second type comprises:
if the second type corresponds to an order allocation mode, determining at least one delivery person corresponding to the first type, and allocating the to-be-allocated order to the delivery person;
if the second type corresponds to an order bidding mode, determining at least one delivery person corresponding to the first type, pushing order bidding information of the to-be-allocated order to a client corresponding to the at least one delivery person, determining, based on an order bidding request sent by the client corresponding to the at least one delivery person, a delivery person that successfully bids an order; and allocating the to-be-allocated order to the delivery person that successfully bids an order;
allocating the to-be-allocated order to a delivery person of a third type comprises:
if the third type corresponds to an order allocation mode, determining at least one delivery person corresponding to the first type, and allocating the to-be-allocated order to the delivery person;
if the third type corresponds to an order bidding mode, determining at least one delivery person corresponding to the first type, pushing order bidding information of the to-be-allocated order to a client corresponding to the at least one delivery person, determining, based on an order bidding request sent by the client corresponding to the at least one delivery person, a delivery person that successfully bids an order; and allocating the to-be-allocated order to the delivery person that successfully bids an order.

22. The apparatus according to claim 21, wherein the historical allocation orders are historically recorded taken orders; and
the apparatus further comprises:
a third construction module, configured to construct a first non-order taking model by using the order subjective attribute;
a fourth construction module, configured to construct a second non-order taking model by using the order objective attribute;
a second model training module, configured to: based on order subjective attributes and order objective attributes of non-taken orders that are historically recorded, associatively train the first non-order taking model and the second non-order taking model, to separately obtain model parameters of the first non-order taking model and the second non-order taking model; and
a threshold determining module, configured to: calculate a reference willingness of the taken order based on the first order taking model or the second order taking model; calculate an average value of the reference willingness of the taken orders, to obtain a first reference value; calculate reference willingness of the non-taken orders based on the first non-order taking model or the second non-order taking model; calculate an average value of the reference willingness of the non-taken orders, to obtain a second reference value; and determine the first determining threshold and the second determining threshold based on the first reference value and/or the second reference value.

23. The apparatus according to claim 21, wherein the allocation unit is specifically configured to:
if the order taking willingness is greater than the first determining threshold, and the order taking willingness is greater than a third determining threshold, allocate the to-be-allocated order to a delivery person that corresponds to the first type and whose delivery person level is higher than a preset level; or
if the order taking willingness is greater than the first determining threshold, and the order taking willingness is less than a third determining threshold, allocate the to-be-allocated order to a delivery person that corresponds to the first type and whose delivery person level is lower than a preset level.

24. The apparatus according to claim 21, wherein the first type and the second type correspond to an order bidding mode, the third type corresponds to an assignment mode, a subjective order taking willingness of the first type is weaker than a subjective order taking willingness of the second type, and the subjective order taking willingness of the second type is weaker than a subjective order taking willingness of the third type; and
the apparatus further comprises:
a first determining module, configured to: after the to-be-allocated order is allocated based on the delivery person of the first type, determine whether the to-be-allocated order is taken after first preset duration;
a first reallocation module, configured to: when a determining result of the first determining module is that the to-be-allocated order is taken after the first preset duration, allocate the to-be-allocated order based on the delivery person of the second type;
a second determining module, configured to: after the to-be-allocated order is allocated based on the delivery person of the second type, determine whether the to-be-allocated order is taken after second preset duration; and
a second reallocation module, configured to: when a determining result of the second determining module is that the to-be-allocated order is taken after the second preset duration, allocate the to-be-allocated order based on the delivery person of the third type.

25. The apparatus according to claim 24, wherein an taken order that is historically recorded is an taken order that is historically allocated to the delivery person of the first type; and
a non-taken order that is historically recorded is a non-taken order that is historically allocated to the delivery person of the first type.

26. The apparatus according to claim 16, wherein the order subjective attribute comprises a delivery income, a delivery distance, and a delivery person level, and the order objective attribute comprises an order read rate and an order waiting time; and
the apparatus further comprises:
a level determining module, configured to: determine, based on a start address of the to-be-allocated order, delivery persons that are located in an area range corresponding to the start address; and use an average delivery person level of the delivery persons within the area range as the delivery person level corresponding to the to-be-allocated order.

27. (canceled)

28. (canceled)

29. (canceled)

30. (canceled)
